(19) United States
(12) Patent Application Publication
(10) Pub. No.: US 2005/0157727 A1
(43) Pub. Date: Jul. 21, 2005

(54) Server, software, and system for data delivery

(75) Inventors: Akira Date, Kunitachi (JP); Mariko Yamada, Tokyo (JP)

Correspondence Address: Stanley P. Fisher;Reed Smith LLP, 3110 Fairview Park Drive, Suite 1400, Falls Church, VA, 22042-4503, US

(73) Assignee: Hitachi, Ltd.

(21) Appl. No.: 10/785,048

(22) Filed: Feb. 25, 2004

(30) Foreign Application Priority Data
Jan. 15, 2004 (JP) 2004-007461

(51) Int. Cl. H04L 12/56

(52) U.S. Cl. 370/395.21

(57) ABSTRACT

A data delivery system. Fragmentation in a communication path is suppressed to prevent increase of load imposed on network appliance due to the fragmentation occurring in the state where traffic is increased, while preventing increasing of load imposed on a receiver terminal due to necessity of reconstructing fragmented packet. When data including plural packets recorded internally of payload of an IP packet is delivered, MTU of communication path is checked to construct the packet(s) in the payload on the basis of the MTU value obtained. Assuming that the terminal moves among networks, a function for messaging the move of the terminal to a delivery server is imparted to the terminal for allowing the MTU of a new communication path to be searched upon generation of the message.

### BACKGROUND OF THE INVENTION

1. Field of the Invention

The present invention relates to a method of reducing a network load imposed on an IP (Internet Protocol) network upon transmission or transportation of multimedia data such as picture or video data. In particular, the present invention is concerned with a method of generating an IP packet in dependence on statuses or situations prevailing in a network interconnecting a sender terminal and a receiver terminal.

2. Description of the Related Art

In the data transmission through the medium of an IP network, a maximum transmission unit (MTU) of data which can be transported or transmitted at a time is determined in dependence on the medium employed for the data transmission. Basically, the MTU is a value set by an operating system (OS). When the IP packet of a size greater than the MTU is received by a sender terminal or a receiver terminal or network appliances (network nodes) installed on a communication channel or path extending between the transmission terminal and the receiver terminal, the IP packet is divided so that the IP packet does not exceed the size of the MTU so far as control flags contained in a header of the IP packet indicates dividableness (fragmentation). On the contrary, when control flags indicate undividableness, the data packet division or fragmentation processing is not executed but the IP packet is discarded. In that case, the value of the MTU of the data link is sent back to the sender terminal together with an unreachableness or undeliverableness message in accordance with ICMP (Internet Control Message Protocol).

As a method of searching the MTU between communication hosts, there is a known method of sending a ping packet of a given length to another host thereby determine the value of the MTU in dependence on the response behavior. More specifically, one of control flags (DF) contained in the IP packet header is set to “1” (Don't Fragment), whereon the ping packet is sent. When the division processing becomes necessary at a node on the way of communication path, the packet is discarded and the MTU value is informed by the ICMP. Then, the succeeding ping packet transmission is carried out in the similar manner by using the MTU value informed by the ICMP. This process is repeated up to a time point at which the undeliverable or unreachable message is no more issued. The MTU determined at this time point represents the effective MTU between the communication hosts.

At the present day, implementation of the network in broad band has made remarkable progress with the communication band of the internet connected to home appliances being increased. Consequently, the number of service providers providing services at a rate of several M-bit/S. is also increasing. Under such circumstances, contents delivery services through the medium of the internet are rising, and picture transmission through the IP network is attracting much interest. Among others, a so-called streaming technique of transmitting picture/voice on a real time basis is drawing attention. As streaming protocols made use of in the IP network, there can be mentioned the UDP (User Datagram Protocol), the RTP (Real-time Transfer Protocol) and the HTTP (HyperText Transfer Protocol) in general.

Further, the technology of IP network is making day-by-day progress, so to say. Although the IP utilized widely at the present day is IPv4 (IP version 4), the connection service conforming to IPv6 (IP version 6) called the next-generation IP is currently spreading. Because of incompatibility between the IPv4 and the IPv6, it is believed that both IPs will coexist for a while by resorting to capsulating, tunneling or the like technique. Furthermore, at the time when the IP was developed, it has been premised that the terminal is fixedly connected to the network for use. However, owing to progress in the radio technology in the recent years, there has arisen a demand for mobilization of the terminal by making use of wireless LAN (Local Area Network). Under the circumstances, mobile IP compatible with the move of the terminal is packaged therein. The mobile IP is represented by a model composed of a mobile node (MN) corresponding to the terminal, a home agent (HA) for managing the MN and a correspondent node (CN), i.e., object for communication of the MN. The home agent (HA) exists in the home network of the MN and manages the IP address of the MN. When the terminal moves from one to another network, the terminal detects the move and registers a new IP address in the home agent. When the CN sends data to the home network address or the MN, then the HA transfers the data to the MN address registered. Further, when the MN moves from one to another network, the HA informs the CN of a new IP address of the MN, in response to which the CN sends data directly to the MN.

As an application brought about by the IP technology and the network of the broad band, there can be mentioned VoIP (Voice over IP). The VoIP is a system which is capable of realizing a real-time voice communication by resorting to the IP network technology. When compared with the conventional system in which the switch or exchange system is adopted, the VoIP system features such advantage that the voice communication can be realized at low cost by making use of the IP network of low communication cost.

Upon reception of an IP packet of a size which exceeds the MTU through a communication channel of an IP network, fragmentation of the packet takes place in the receiver appliance. As a result, load imposed on that appliance increases because of necessity of executing a defragmentation processing. Furthermore, in the final destination terminal, load will also increase due to the processing for reconstructing or restructuralizing the fragmented packet.

### SUMMARY OF THE INVENTION

In the light of the state of the art described above, it is an object or the present invention to suppress fragmentation of IP packet in a communication channel or path to thereby prevent increase of load imposed on network appliance from increasing due to fragmentation in a heavy traffic situation.

It is also an object of the present invention to prevent increase of a load imposed on a receiver terminal due to reconstruction or restructuralization of the fragmented packet.

In view of the above and other objects which will become apparent as the description proceeds, there is provided according to a first aspect of the present invention a server for delivering data having one or plural packets additionally recorded internally of payload of an IP packet, which server is arranged such that a data packet is constructed or structuralized through cooperation of a search module which is designed for determining an MTU of a network extending between the server and a receiver terminal upon starting of delivery or dispatch of the data packet and a data packet generation module which is designed for generating the data packet on the basis of a value determined by the search module, whereon the data packet is delivered to the receiver terminal.

Further, according to a second aspect of the present invention there is provided a system for delivering data having a plurality of packets additionally recorded internally or payload of an IP packet, which system is arranged such that when a terminal requests for delivery of a data packet, the terminal sends a packet for searching the MTU of the network to a server, in response to which the server determines the MTU upon reception of the above-mentioned packet for searching the MTU, whereon the data packet is created or structured by a data packet generation module on the basis of a determined value of the MTU to be subsequently delivered to the above-mentioned terminal.

Furthermore, there is provided according to a third aspect of the present invention such arrangement that in the system according to the first aspect of the invention, a home agent managing a network of a terminal detects move of the terminal to thereby message the move of the terminal to the server which then the server responds to the message by determining the MTU of the network extending between the server and the terminal.

Moreover, provided according to a fourth aspect of the present invention is such arrangement that in the system according to the third aspect of the invention, when a terminal moves from one to another network, a terminal messages the move thereof to a server delivering the data packet, which server then responds to the message to thereby determine the MTU of a network currently extending between the server and the terminal.

Additionally, provided according to a fifth aspect of the present invention is such arrangement that in the system according to the fourth aspect of the invention, when a terminal moves from one to another network, the terminal sends a packet for searching the MTU of the network to the server delivering the data packet, which server then responds to reception of the packet for searching the MTU, to thereby determine the MTU.

By virtue of the first aspect of the present invention, fragmentation of the IP packet in the communication channel or path can be suppressed because the MTU is determined in advance by the server. Thus, the load imposed on the appliance which must otherwise execute the packet defragment processing can be prevented from increasing. Besides, since the restructuralize processing of the fragmented packet can be avoided in the receiver terminal, the load imposed thereon can be suppressed from increasing. Moreover, because the MTU is automatically set by the server, the user need not pay attention to the setting of the MTU at all.

Owing to the second aspect of the present invention according to which the terminal sends the packet for the MTU search and at the time point when the packet suffering no fragmentation has arrived at the server, the size of the packet is set as the size of the MTU. Thus, the MTU can be determined rather straightforwardly. By virtue of this arrangement, the processing load imposed on the network appliances on the communication channel or path and the receiver terminal can be suppressed similarly to the arrangement according to the first aspect of the invention. Further, the user need not pay attention to the setting of the MTU at all.

With the arrangement according to the third aspect of the invention in which upon changeover or switching of the network due to the move of the terminal, the home agent which is in charge of managing the move of the terminal messages the move of the terminal to the server delivering the packet data, the server can determine the MTU of the network after the move of the terminal. The user need not pay attention to the move of the terminal at all.

Owing to the arrangement according to the fourth aspect of the invention in which upon exchange or switching of the network due to the move of the terminal, the terminal messages the move thereof to the server delivering the packet data, the server can determine the MTU of the network after the move of the terminal. The user need not pay attention to the move of the terminal at all.

By virtue of the arrangement according to the fifth aspect of the invention in which upon exchange or switching of the network due to the move of the terminal, the latter sends the packet for searching the MTU, the size of the packet arriving at the server without suffering any fragmentation represents the MTU at that time point. The user need not take into consideration the move of the terminal and the setting of the MTU.

The above and other objects, features and attendant advantages of the present invention will more easily be understood by reading the following description of the preferred embodiments thereof taken, only by way of example, in conjunction with the accompanying drawings.

Other objects, features and advantages of the invention will become apparent from the following description of the embodiments of the invention taken in conjunction with the accompanying drawings.

### BRIEF DESCRIPTION OF THE DRAWINGS

In the course of the description which follows, reference is made to the drawings, in which:

FIG. 1 is a view showing schematically a configuration of a data packet delivery system according to a first embodiment of the present invention (most preferred mode for carrying out the present invention);

FIG. 2 is a view for illustrating an example of an IP and a structure of data for delivery;

FIG. 3 is a view showing a datagram of the IP packet;

FIG. 4 is a view showing a UDP (User Datagram Protocol) packet header;

FIG. 5 is a view showing an RTP (Real-time Transfer Protocol) packet header;

FIG. 6 is a view showing an arrangement of terminal processing in the data packet delivery system according to a second embodiment of the present invention;

FIG. 7 is a view showing an arrangement of delivery server processing in the data packet delivery system according to the second embodiment of the invention;

FIG. 8 is a view showing an arrangement of terminal processing in the data packet delivery system according to a third embodiment of the present invention;

FIG. 9 is a view showing an arrangement of delivery server processing in the data packet delivery system according to the third embodiment of the invention;

FIG. 10 is a view showing an arrangement of delivery server processing in the data packet delivery system according to a fourth embodiment of the present invention;

FIG. 11 is a view showing an arrangement of delivery server processing in the data packet delivery system according to a fifth embodiment of the present invention;

FIG. 12 is a view showing an arrangement of terminal processing in the data packet delivery system according to the fifth embodiment of the present invention;

FIG. 13 is a view showing generally and schematically a VoIP (Voice over IP) system in a most simplified configuration; and

FIG. 14 is a view showing an arrangement of terminal processing in the data packet delivery system according to a sixth embodiment of the present invention.

### DETAILED DESCRIPTION OF THE EMBODIMENTS

The present invention will be described in detail in conjunction with what is presently considered as preferred or typical embodiments thereof by reference to the drawings.

### Embodiment 1

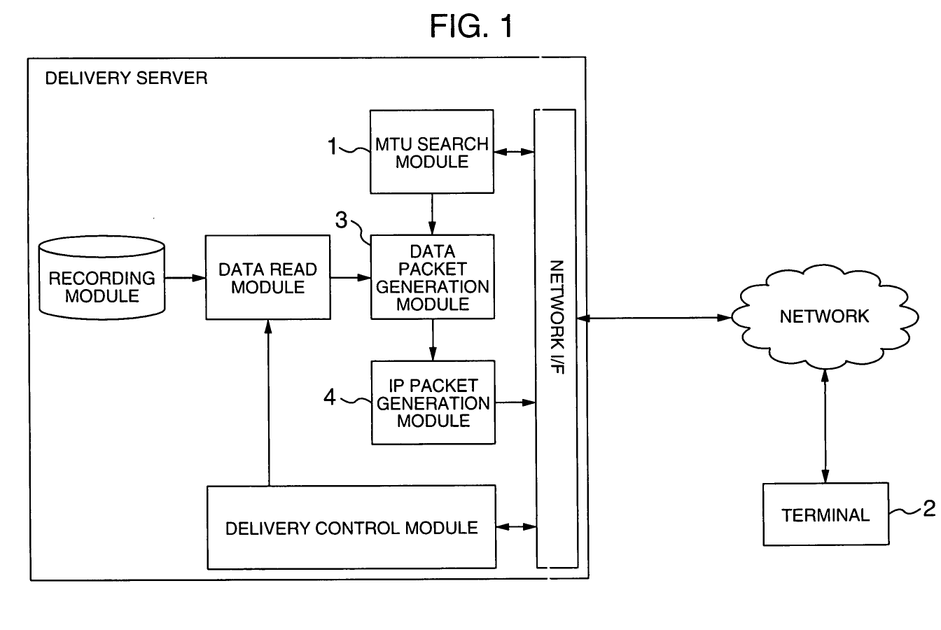

FIG. 1 shows a configuration of a data packet delivery server according to a first embodiment of the present invention. In the figure, reference numeral 1 denotes an MTU search module for searching an MTU (Maximum Transmission Unit) of a network extending from a delivery server to a terminal 2, numeral 3 denotes a data packet generation module for packeting data to be delivered in the form of a data packet, and reference numeral 4 denotes an IP packet generation module for transforming the data packet generated by the data packet generation module 3 to an IP packet to be sent out.

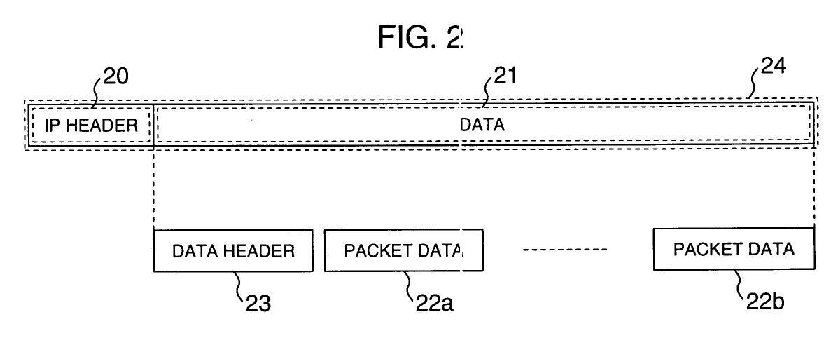

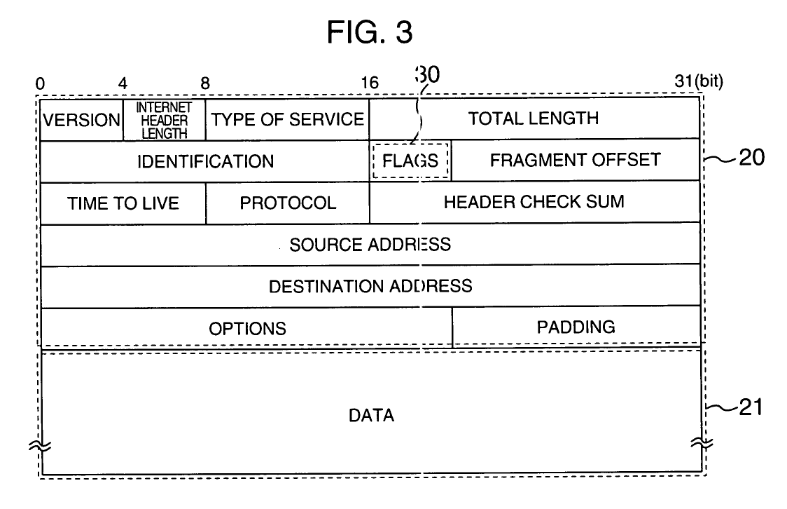

The MTU search module 1 is programmed or designed to search the MTU of the network extending to the terminal 2 upon sending out the data packet. Incidentally, the search of the MTU can be carried out by the conventional method described hereinbefore in conjunction with the related art. The data packet generation module 3 generates the data packet by taking into account the MTU as determined. In this conjunction, it is assumed, by way of example, that the data now concerned is an MPEG-TS (Moving Picture Experts Group-Transport Stream) which is a sort of picture code data. The packet of MPEG-TS (hereinafter referred to as the TS packet for short) is a packet of the fixed length of 188 bytes. The IP packet is basically constituted by an IP header field 20 and a data field 21, as is illustrated in FIG. 2. The TS packet is stored in the data field 21 as packet data 22a, 22b (generally designated by 22). FIG. 3 is a view showing a datagram of the IP packet. DF flag in determination of the MTU is allocated to one bit contained in a flag 30 of 3 bits which is located in the header. When the DF flag is set to “1”, this means that the packet is dividable while the flag set to “0” means that the packet is undividable.

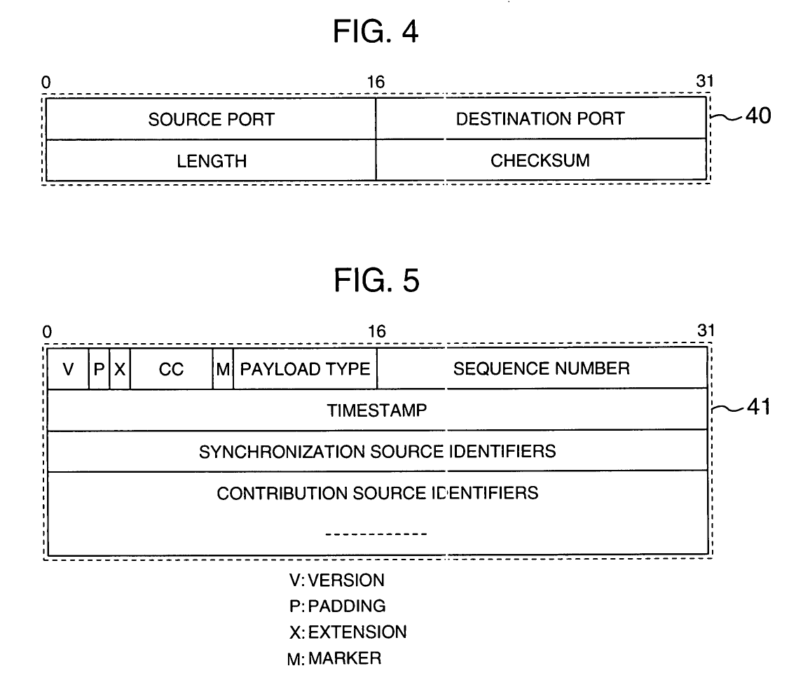

As the data header 23, there can be mentioned a UDP header 40 (see FIG. 4) and an RTP header 41 (see FIG. 5) which are added by a transport layer for transmitting the packet data 22. Similarly, in the case of the transmission by the HTTP (HyperText Transfer Protocol), an HTTP header is allocated as the data header 23 while a TS packet or the TS packet added with the UDP (User Datagram Protocol) header 40 or the TS packet added with the RTP (Real-time Transfer Protocol) header 41 is allocated as the packet data 22, whereon the processing described below is executed. The data packet generation module 3 determines the size of the data 21 which does not exceed the value of the MTU upon constituting the data 21 of the IP packet on the basis of the packet data 22 and the data header 23. In that case, the number Nd of the packet data 22 is so determined as to satisfy the undermentioned condition:
Lm>Ld·Nd+Lh+Li (Exp. 1)
where
Ld represents the size of the packet data 22,
Nd represents the number of the packet data 22 to be transmitted with a single IP packet,
Lh represents the size of the data header 23,
Li represents the size of the IP header 20, and
Lm represents the value of the MTU as determined.

In this conjunction, it is noted that the data transmission can be carried out at an enhanced efficiency when the number of the packet data 22 to be transported in one IP packet is large. Accordingly, the maximum Nd which satisfies the condition given by the expression (Exp. 1) is arithmetically determined in accordance with the undermentioned expression (Exp. 2):
Nd=(Lm−Lh−Li)/Ld (Exp. 2)

The packet data of the number which is equal to the value of Nd determined in this way are constituted in the data packet generation module 3, while in the IP packet generation module 4, the data constituted by the data packet generation module 3 is structuralized as the packet data 22 which is then sent out onto the network.

At this juncture, it is to be added that there may arise such case where the packet data 22 inclusive of the data header 23 in addition can not meet the value Lm of the MTU when the processing makes transition from the data packet generation module 3 to the IP packet generation module 4. In that case, the data packet generation module 3 may transfer the processing of data for transmission to the IP packet generation module 4.

### Embodiment 2

In the data packet delivery system according to the first embodiment of the invention, arrangement is made such that the MTU is searched by the server. By contrast, in the case of a second embodiment of the invention, the data packet delivery system is so arranged that the terminal searches the MTU and messages the result of the search to the server.

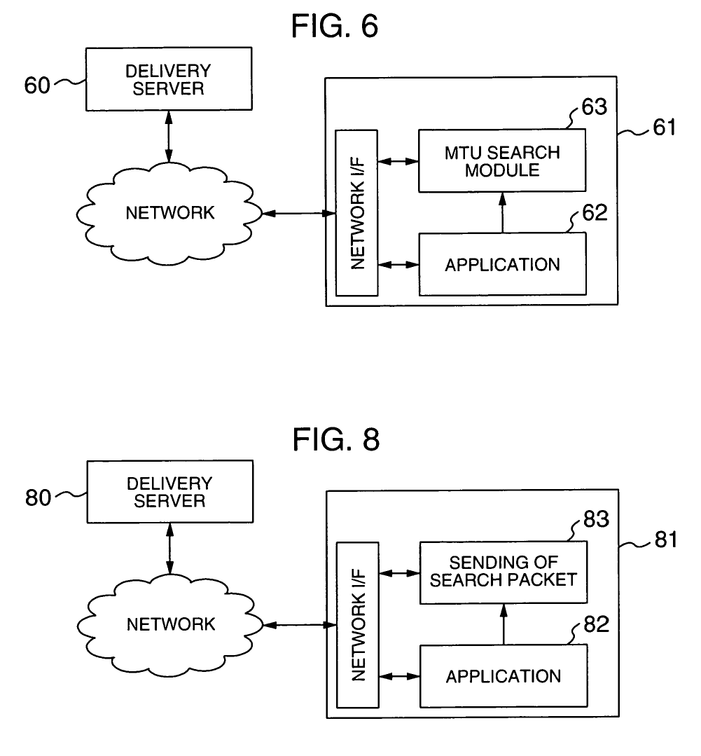

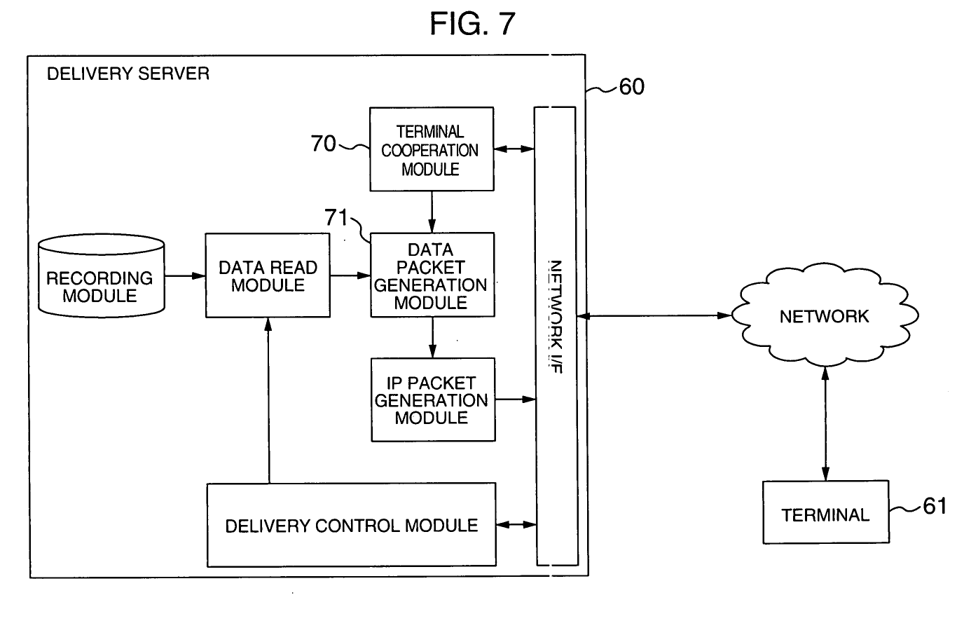

The data packet delivery system according to the instant embodiment of the invention will be described by reference to FIGS. 6 and 7. In FIG. 6, reference numeral 60 denotes a delivery server, and 61 denotes a receiver terminal. The delivery server 60 is comprised of a conventional or hitherto known application 62 for receiving the data transmitted from the delivery server 60 by way of the network and an MTU search module 63 for searching the MTU available between the delivery server 60 and the receiver terminal 61.

When the application 62 issues a request for the data delivery to the delivery server 60, the MTU search module 63 can determine the MTU by resorting to the method similar to that described previously in conjunction with the first embodiment of the invention. In succession, the MTU search module 63 messages the value of the MTU as obtained to the delivery server. In the messaging method, an ordinary TCP (Transmission Control Protocol) can be adopted. Further, when the application 62 issues the delivery request to the delivery server 60, the former can message or designate the MTU as the delivery request data. Referring to FIG. 7, the delivery server 60 receives the MTU message from the receiver terminal 61 at a terminal cooperation module 70. The value or the MTU as received is transferred to a data packet generation module 71. In succession, processing similar to that described hereinbefore in conjunction with the first embodiment of the invention is executed.

### Embodiment 3

In the case of the data packet delivery system according to the second embodiment of the invention, the terminal performs the MTU search and messages the value acquired to the server. The data packet delivery system according to a third embodiment of the present invention is so arranged that the terminal sends a search packet while the server detects the search packet, to thereby acquire the value of the MTU.

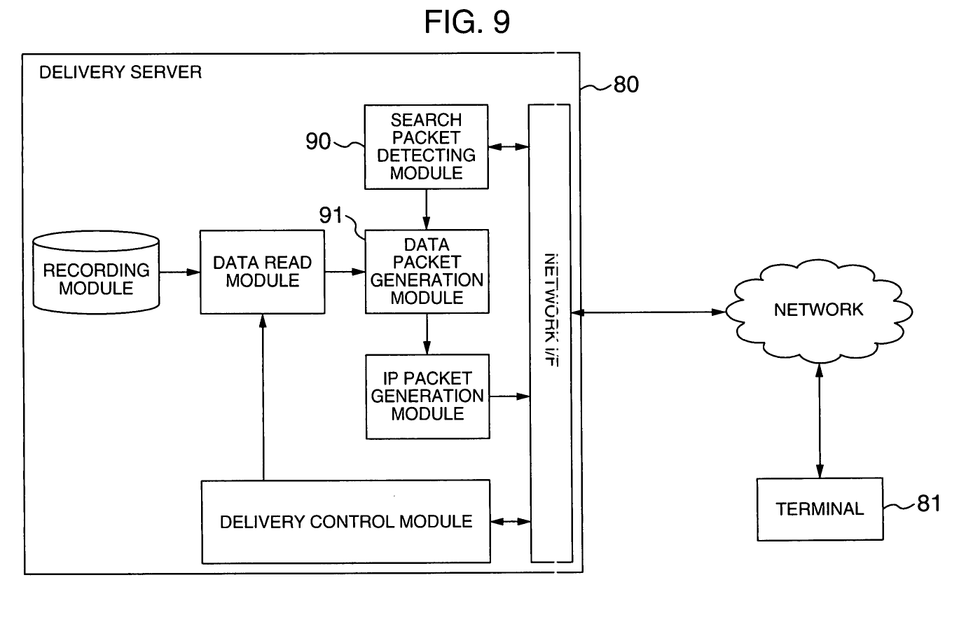

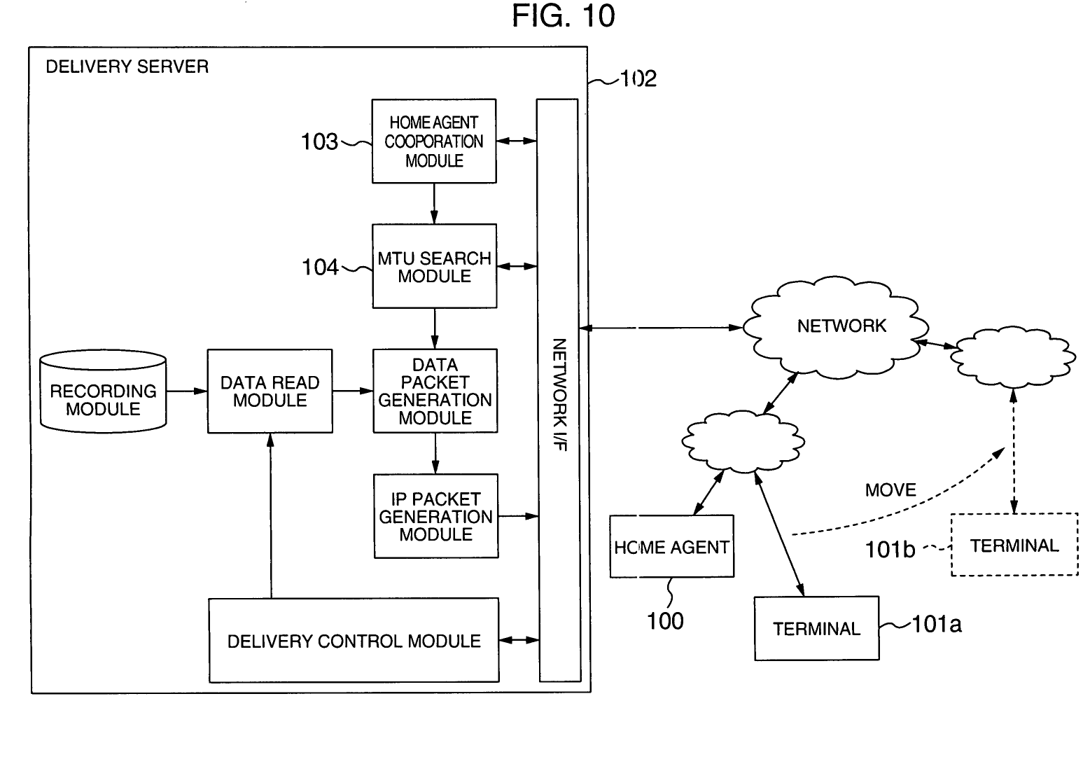

The data packet delivery system according to the third embodiment of the invention will be described by reference to FIG. 8 and FIG. 9. In FIG. 8, reference numeral 80 denotes a delivery server, and numeral 81 denotes a receiver terminal. The receiver terminal 81 is composed of a conventional application 82 which receives the data sent from the delivery server 80 by way of the network and a search packet sending module 83 for transmitting or sending a search packet to the delivery server 80.

When the application 82 issues a request for the delivery of data to the delivery server 80, the search packet sending module 83 sends a ping packet to The delivery server 80 as the search packet with the division enable flag being invalidated. Upon reception of the ICMP (Internet Control Message Protocol) packet messaging undeliverableness or unreachableness, the ping packet is resized to the size of the MTU as messaged, whereon the ping packet is again sent out. This process is repeated until no undeliverableness message arrives. On the other hand, in the delivery server 80 shown in FIG. 9, the search packet issued from the receiver terminal 81 is detected by a search packet detecting module 90. In that case where the size of the search packet sent from the receiver terminal 81 exceeds the value of the MTU available between the delivery server 80 and the receiver terminal 81, the search packet is unable to reach the delivery server 80. When the search packet size is equal to or smaller than the value of the MTU, the search packet can reach the delivery server 80. Accordingly, the size of the search packet as detected by the search packet detecting module 90 is treated as the value of the MTU. The value thus acquired is informed to a data packet generation module 91, which is then followed by execution of the processing similar to that described hereinbefore in conjunction with the first embodiment of the invention.

### Embodiment 4

The data packet delivery system according to a fourth embodiment of the present invention is so arranged that when a terminal packaging therein a mobile IP moves from one to another networks, a home agent of that terminal cooperates with the delivery server to thereby cause the delivery server to search the MTU of the communication channel or path intervening between the delivery server and the terminal moved.

The fourth embodiment of the present invention will be described by referring to FIG. 10 in which reference numeral 100 denotes a home agent which is in charge of managing a terminal 101, and numeral 102 denotes a delivery server. When the terminal 101a moves from one to another network to be connected to a new network, as indicated by 10b, then the IP address of the new network is imparted to the terminal 101b with the function of the mobile IP. The terminal 101b for which the new IP address has been set registers the new IP address in the home agent managing the terminal 101b. In response, the home agent 100 messages the IP address of the terminal 101b corresponding to the MN (Mobile Node) to the delivery server 102 corresponding to the CN (Correspondent Node). The home agent incorporated in the delivery server 102 detects the message of the new IP address of the terminal 101b. Thus, the change of the network of the terminal can be recognized. A home agent cooperation module 103 issues the MTU search processing command to an MTU search module 104, in response to which the MTU search module 104 searches the MTU between the delivery server 102 and the terminal 101b. In succession, processing similar to that described hereinbefore in conjunction with the first embodiment of the invention is executed.

### Embodiment 5

The data packet delivery system according to a fifth embodiment of the present invention is arranged in such configuration that when the terminal packaging therein the mobile IP moves from one to another network, the terminal searches the MTU of a communication channel or path extending to the delivery server, to thereby inform the delivery server of the MTU searched or determined.

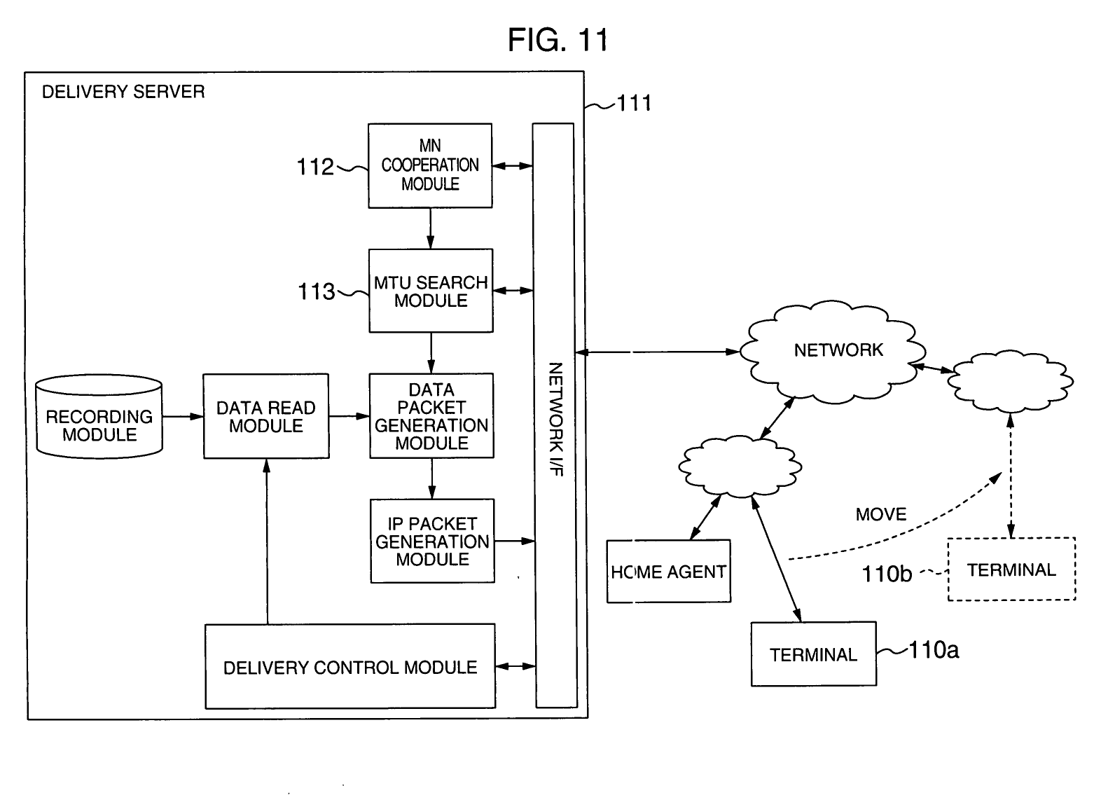

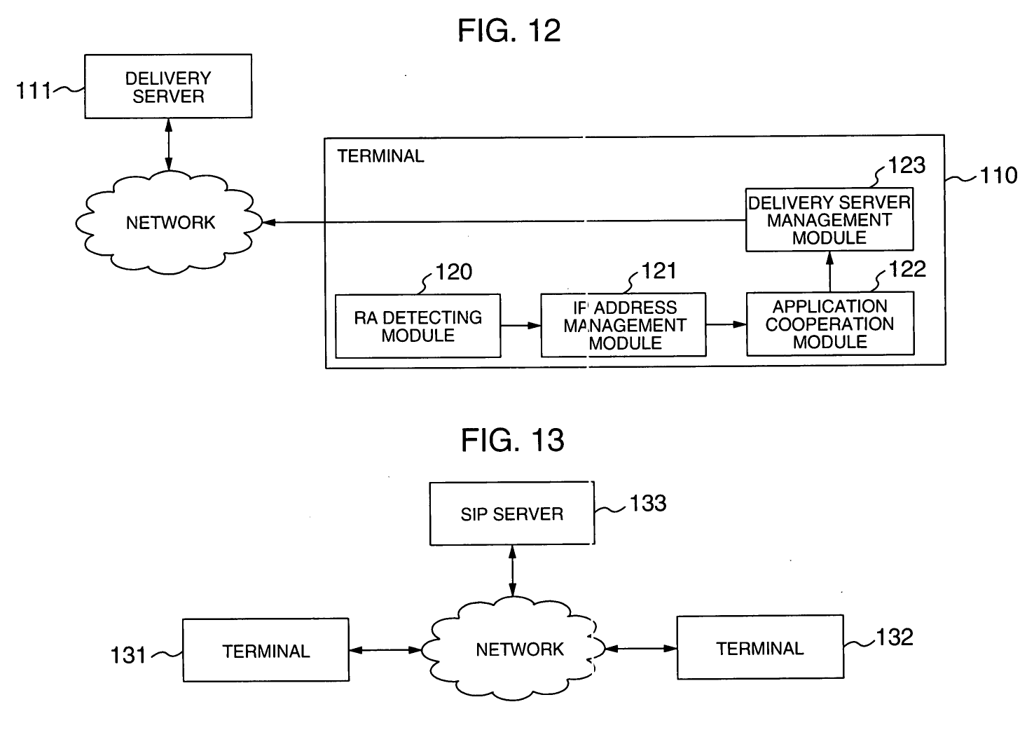

Referring to FIG. 11, when a terminal 110 moves from a network indicated by 110a to a network indicated by 10b, a new IP address is set. Referring to FIG. 12, in the terminal 110, an RA detecting module 120 incorporated in the terminal 110 detects an RA (Router Advertisement) from a network appliance with the function of the mobile IP, to thereby set a new IP address at an IP address management module 121 when the terminal 110 moves to a new network. At this time point, the RA detecting module 120 messages change of the network to an application cooperation module 122 and additionally messages the IP address of the delivery server 111 to a delivery server management module 123, which in turn messages the change of the network of the terminal to the delivery server 111. The message of the network change of the terminal is received by an MN (Mobile Node) cooperation module 112, which then informs the network change of the terminal to an MTU search module 113 for causing the MTU search module 113 to search the MTU between the delivery server 111 and the terminal 110b. The subsequent processing is similar to that described hereinbefore in conjunction with the first embodiment of the invention.

### Embodiment 6

In conjunction with the first to fifth embodiments, description has been made on the assumption that the data packet is the MPEG-TS (Moving Picture Experts Group-Transport Stream). A sixth embodiment of the present invention is directed to a VoIP (Voice over IP) system, i.e., a voice communication system.

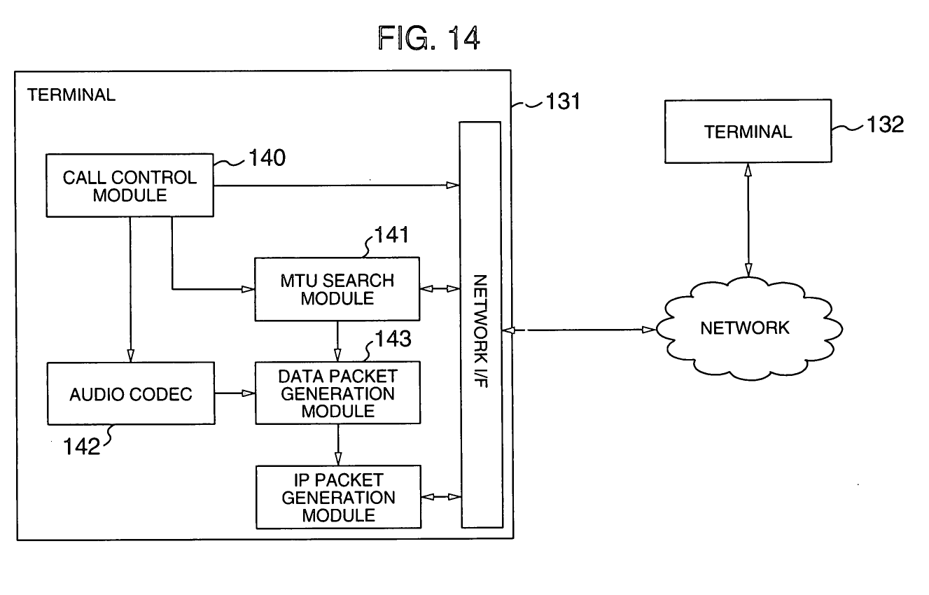

FIG. 13 is a view showing generally and schematically a VoIP system in a most simplified configuration. Upon communication between a terminal 131 and a terminal 132, an SIP (Session Initiation Protocol) server 133 is in charge of call control. By way of example, in the case where the terminal 131 issues a call to the terminal 132, a request for connection to the terminal 132 is issued to the SIP server 133. When the connection is possible, the SIP server sends IP addresses of the mated communication parties for allowing the communication to be performed between the mated parties, i.e., the terminal 131 and the terminal 132. Referring to FIG. 14, upon establishment of the communication of the terminal 131 with the communication mate terminal 132, a call control module 140 issues a corresponding message to an MTU search module 141 which responds thereto by searching the MTU between the terminal 131 and the communication mate terminal 132. It has been described in conjunction with the first embodiment of the invention that the packet length of the MPEG-TS is fixed to 188 bytes. By contrast, in the case of the VoIP system, the audio codec scheme can be selected. However, once the codec has been determined, the data packet length is fixed. Accordingly, it is possible to construct the data packet which does not exceed the MTU value in a data packet generation module 143 in accordance with the expression (Exp. 2) with the packet length at that time being represented by Ld. Subsequently, the processing similar to that described hereinbefore in conjunction with the first embodiment of the invention is executed.

It should be further understood by those skilled in the art that although the foregoing description has been made on embodiments of the invention, the invention is not limited thereto and various changes and modifications may be made without departing from the spirit of the invention and the scope of the appended claims.

1. A data delivery server connected to a terminal by way of a network for delivering an IP packet having data packet recorded internally of payload, comprising:
a search module for determining a maximum value of size of one IP packet capable of passing through a channel on said network extending from said server to said terminal,
a packet generating module for determining the number of said data packets to be stored in the payload of the IP packet on the basis of said maximum value to thereby implement the determined number of said data packets internally of the payload of said IP packet, and
an input/output unit for delivering said IP packet generated by said packet generating module.

2. A data delivery server according to claim 1,
said terminal being a mobile terminal,
further comprising a move detecting module designed for accepting a move message of said mobile terminal,
wherein said search module determines said maximum value when move of said mobile terminal is detected by said move detecting module.

3. A data delivery server according to claim 2,
said mobile terminal corresponding to MobileIP,
wherein said move detecting module is so designed as to accept a message of the move of said mobile terminal sent from a home agent of said mobile terminal defined by said MobileIP.

4. A data delivery server according to claim 1,
wherein said search module determines said maximum value by transmitting a plurality of packets of different data quantities toward said terminal.

5. A data delivery software capable of carrying out a data delivery method with a computer including a CPU and an input/output unit,
comprising the steps of:
determining with said CPU a maximum value of data quantity capable of being transferred with one IP packet by way of a path on a network extending from a server to a terminal;
determining with said CPU the number of data packets to be stored internally of payload of said IP packet on the basis of said maximum value;
implementing with said CPU the determined number of said data packets internally of the payload of said IP packet; and
delivering the generated IP packet from said input/output unit.

6. A data delivery software capable of carrying out the data delivery method with the computer according to claim 5,
further comprising a step of:
accepting a move message concerning move of said terminal,
wherein upon reception of said move message, the step of determining said maximum value is executed.

7. A data delivery software capable of carrying out the data delivery method with the computer according to claim 5,
said terminal being a mobile terminal corresponding to MobileIP,
wherein a move message of said terminal is a move message of said mobile terminal sent from a home agent of said mobile terminal.

8. A data delivery system comprised of a server for delivering data including one or plural data packets additionally recorded internally of payload of an IP packet and a terminal connected to said server by way of a network for receiving said data,
wherein said server comprises:
a search module for determining a maximum value of data quantity capable of being transferred with one IP packet by way of a path on said network extending from said server to said terminal;
a packet generating module for structuralizing said determined number of data packets internally of the payload of said IP packet; and
an input/output unit for delivering said IP packet generated by said packet generating module, and
wherein said terminal comprises an input/output unit for receiving the data delivered from said server.

9. A data delivery system according to claim 8,
wherein said search module determines said maximum value by transmitting a plurality of packets of different data quantities toward said terminal.

10. A data delivery system according to claim 8,
wherein said server includes a terminal cooperation module in place of said search module,
said terminal further comprises a search module for determining a maximum value of data quantity capable of being transferred by one IP packet by way of a path on said network extending from said terminal to said server,
said terminal cooperation module of said server is so arranged as to acquire from said terminal information concerning said maximum value determined by said search module of said terminal, and
wherein the packet generating module incorporated in said server determines the number of said data packets to be stored internally of the payload of said IP packet on the basis of said maximum value determined by said terminal cooperation module, to thereby structuralize said determined number of data packets internally of the payload of said IP packet.
